(19) United States
(12) Patent Application Publication
(10) Pub. No.: US 2003/0041071 A1
(43) Pub. Date: Feb. 27, 2003

(54) Database Management system and database

(75) Inventors: Hideyuki Wakai, Kanagawa (JP); Takashi Kurihara, Kanagawa (JP); Hirobumi Miwa, Kanagawa (JP); Tatsuya Kitamura, Kanagawa (JP); Akihiro Takiguchi, Kanagawa (JP); Junbo Song, Kanagawa (JP)

Correspondence Address: ARMSTRONG,WESTERMAN & HATTORI, LLP, 1725 K STREET, NW., SUITE 1000, WASHINGTON, DC, 20006, US

(73) Assignee: KOMATSU LTD., Tokyo (JP)

(21) Appl. No.: 10/224,565

(22) Filed: Aug. 21, 2002

(30) Foreign Application Priority Data
Aug. 22, 2001 (JP) 2001-251139
Oct. 29, 2001 (JP) 2001-330995

(51) Int. Cl. G06F 7/00

(52) U.S. Cl. 707/103 X; 707/103 Z

(57) ABSTRACT

The present invention provides a database for implementing in a straightforward manner the sharing of a variety of touchpoint information between departments in an enterprise or the sharing of a variety of touchpoint information between enterprises.

Event objects, each having one or a plurality of types of touchpoint information in accordance with the contents of each event, are generated in response to event messages such as status change information, instruction information, and the like, generated externally at a variety of times. Event objects of different types which are generated from the same event are mutually related by simultaneity links. Event objects of the same type which adjoin one another on a time base are mutually related by time base links, and, as a result, an event chain in which event objects of the same type are serially linked along the time base is formed for each touchpoint information type. As a result of a relationship between event objects that is of a mesh structure formed by simultaneity links and time base links, retrieval of touchpoint information of different types generated simultaneously, or the retrieval of a chronological history of touchpoint information of the same type, for example, can be performed at high speed.

### BACKGROUND OF THE INVENTION

1. Field of the Invention

The present invention relates to a database system.

2. Description of the Related Art

The description that follows is based on the example of a data base used in an enterprise. In many enterprises, individual applications, databases, and the like are conventionally provided for each department or business task. In addition, various types of information produced by each department or business task are stored individually in an application or database for each department or for each business objective. For example, in a given enterprise which undertakes machine rentals, information generated in the sales department upon receiving a communication from a customer regarding a machine failure is stored as touchpoint information with respect to the customer in a customer-related database which is utilized by a sales department application for example, and information generated when a service employee in the service department repairs the machine maybe stored as touchpoint information with respect to the machine in a machine management database for example, or maybe stored as touchpoint information with respect to a service employee in a service employee operation management database, for example.

Conventionally, such databases are structured databases called “relational databases” (RDB). In an RDB, tables are used to establish relationships between different types of touchpoint information. When there is a desire to extract and simultaneously reference related touchpoint information from among a variety of touchpoint information individually managed on different databases as described above, desired related touchpoint information can be retrieved by using relationships in accordance with RDB tables.

However, the prior art is confronted by the following problems:

Firstly, the extraction of desired related touchpoint information from among a large volume of stored data necessitates a long retrieval time. One cause of this is that relationships between information in the RDB result in a tree structure using a multiplicity of tables. Consequently, when related touchpoint information is retrieved, this multiplicity of tables must be referenced in order, which takes a long time.

Secondly, the required table types and large volumes of data thereof in order to skillfully establish relationships between a variety of types of touchpoint information lead to a requirement for an extremely large storage capacity.

Thirdly, when new types of touchpoint information are to be added, the redesign of the database is extremely labor-intensive, time-consuming and costly. This is true because, not only does this involve designing a new database to store these new types of touchpoint information, but the following variety of operations must also be carried out. For example, the internal structure of the existing database which stores the existing types of touchpoint information must be investigated beforehand. Then, based on the results of this investigation, the interface with respect to the new database, which the existing database is supposed to have, must be newly designed. Furthermore, in many cases, both the structure of the existing database itself and also the applications must be remodeled so as to skillfully work in conjunction with the new database.

Fourthly, there has been a demand in recent years to construct an integrated database management system that mutually relates a plurality of databases, which hitherto have been independently installed in each department or enterprise, in order to allow information to be shared between different departments or enterprises. However, because, as per the third problem described above, redesigning a database is labor-intensive, time-consuming and costly, such a system is nearly impossible for large-scale systems in particular.

Fifthly, when given touchpoint information is generated from a given event, there are times when the desire exists to newly generate a separate event which is linked with this touchpoint information; for example, in a case where, when customer touchpoint information is generated by an event in which a sales department receives a claim from a customer for example, there is a desire to generate an event in which an instruction is sent to the service department to deal with this claim, this event being linked with this customer touchpoint information. In such a case, according to the prior art, a special application for event generation must be created in addition to a database management system.

### SUMMARY OF THE INVENTION

The present invention was conceived in view of the foregoing problems, an object thereof being to permit high-speed retrieval of different types of related touchpoint information.

Another object of the present invention is to relate different types of touchpoint information with a small storage capacity.

It is yet another object of the present invention to permit the straightforward addition of new types of touchpoint information.

It is yet another object of the present invention to provide a database system which can easily implement the sharing of a variety of touchpoint information between departments or between enterprises.

It is yet another object of the present invention to make it possible, when given touchpoint information is generated, to automatically generate required events linked with this touchpoint information, without a special application and by using the database management system by itself.

In the description in this text, figures in brackets illustrate correspondence relationships with elements appearing in the attached drawings. This illustration only serves to simplify the description and is not intended to limit the technological scope of the present invention.

The database management system (10) according to a first aspect of the present invention comprises: event message decoding means (2) for inputting and decoding an event message (1A) indicating an event; event object generating means (3) for generating in a database (20), in response to a decoding result for each event message, one or more types of event object (4A to 4C) each having one or more types of touchpoint information in accordance with the decoding result; means for forming a simultaneity link (5) between event objects (4A, 4B) of different types which are generated from the same event; and means (3) for forming a time base link (6) between event objects (4B, 4C) of a same type that adjoin one another on a time base.

In a preferred embodiment, the database management system further comprises: event object retrieving means (7) for retrieving from the database, in response to a decoding result for each event message, one or more desired event objects which are directly or indirectly related by the simultaneity link or the time base link with respect to one or more types of touchpoint information in accordance with the decoding result.

In a preferred embodiment, the database management system further comprises: event message creating means (2) for creating, based on an event message inputted from outside or a retrieved event object, a new event message which is outputted to outside.

In a preferred embodiment, the database management system further comprises: message converting means (170) for inputting an external message relating to an event outputted from an external system (200) and for converting the inputted external message into an event message and outputting same to the event message decoding means (2). Also, the message converting means (170) further inputs an event message (1B) outputted from the event message creating means (2), converts the inputted event message (1B) into an external message for the external system (200) and outputs this converted external message to the external system (200).

In a preferred embodiment, at least one operating method selected from among a plurality of types of operating method (722, 812, 912, 916), and data related to the event (723, 813, 913, 914, 917) are described in an event message inputted to the event message decoding means (2). Also, the event message decoding means (2) selects, in accordance with an operating method described in a decoded event message, the event object generating means (3), the event object retrieving means (7) or the event message creating means (2). The selected event object generating means (3), the event object retrieving means (7) or the event message creating means (2) performs respective processing using data described in the decoded event message.

In a preferred embodiment, the event object generating means (3), the event object retrieving means (7) and the event message creating means (2) are constituted by a plurality of operating objects (506, 601). Operating object information (503) for defining operating objects corresponding with a variety of event message types which can be inputted from outside and with a variety of operating methods which can be described in each event message is further provided. In addition, the event message decoding means (2) selects, based on the operating object information (503), one or more operating objects corresponding with the decoded event message type and with an operating method described in the event message. The selected operating object(s) perform(s) respective processing using data described in the decoded event message. The operating object information (503) is rewritable.

In a preferred embodiment, the database management system further comprises: system information management means (505) for storing system information comprising definition information and constraint information relating to the structure of event messages and event objects. In addition, the event message decoding means (501), the event object generating means (506), the simultaneity link forming means (506), and the time base link forming means (506) use system information in the system information management means (505) to correctly control respective processing.

In a preferred embodiment, means for decoding events and means for outputting events describe an event in a script of a predetermined format (for example, an XML script) such that this script can then be exchanged with the outside.

A database construction method according to another aspect of the present invention comprises the steps of: inputting and decoding an event message indicating an event; generating in a database, in response to a decoding result for each event message, one or more types of event object each having one or more types of touchpoint information in accordance with the decoding result; forming a simultaneity link between event objects of different types which are generated from the same event; and forming a time base link between event objects of a same type that adjoin one another on a time base.

The present invention also provides a computer program for causing a computer to execute this database construction method.

An event management database according to yet another aspect of the present invention comprises: event objects (4A, 4B, 4C) of a plurality of types, each having touchpoint information in accordance with the contents of a generated event. Event objects (4A, 4B) of different types which are based on the same event are interrelated by a simultaneity link (5). Event objects (4B, 4C) of the same type which adjoin one another on a time base are interrelated by a time base link (6) to form event chains (30, 40, 50) of each event object type.

In a preferred embodiment, touchpoint information entity data (130) possessed by event objects in the event chains (30, 40, 50) are not present in the event objects themselves but rather are present in one or more external systems (60, 70, 80, 90) outside the database. In addition, the event objects are [each] related with touchpoint information entity data (130) in the external systems (60, 70, 80, 90) by means of a logical link (110).

An integrated system according to yet another aspect of the present invention comprises: an event management database system (100); and one or more external systems (60, 70, 80, 90) capable of communicating with the database system (100). The database system (100) comprises event objects (4A, 4B, 4C) of a plurality of types, each having touchpoint information in accordance with the contents of an event generated in the external systems (60, 70, 80, 90). Also, event objects (4A, 4B) of different types which are based on the same event are interrelated by a simultaneity link (5). In addition, event objects (4B, 4C) of the same type which adjoin one another on a time base are interrelated by a time base link (6) to form event chains (30, 40, 50) of each event object type. Further, each of the external systems (60, 70, 80, 90) is capable of accessing touchpoint information relating to an event generated in another external system by communicating with the database system (100).

In a preferred embodiment, the external systems (60, 70, 80, 90) have touchpoint information entity data (130) possessed by event objects in the event chains (30, 40, 50). Further, each of the entity data (130) are related with corresponding event objects in the event chains (30, 40, 50) by means of a logical link (110).

### BRIEF DESCRIPTION OF THE DRAWINGS

FIG. 1 is a block diagram showing the configuration of the database construction device according to an embodiment of the present invention;

FIG. 2 is a block diagram showing an example of a data structure within the database 20 constructed by the database management system 10 in FIG. 1;

FIG. 3 is a block diagram showing an example of a stage at a midpoint point toward construction of the data structure shown in FIG. 2;

FIG. 4 is a block diagram showing an example of a stage at a midpoint point toward construction of the data structure shown in FIG. 2;

FIG. 5 is a block diagram showing an example of a stage at a midpoint point toward construction of the data structure shown in FIG. 2;

FIG. 6 is a block diagram showing an example of a stage at a midpoint point toward construction of the data structure shown in FIG. 2;

FIG. 7 is a block diagram showing the configuration of an embodiment that implements information sharing between a plurality of departments in an enterprise by using the database system of the present invention;

FIG. 8 is a block diagram which more specifically shows a configuration inside the database system of the embodiment in FIG. 7 and the configuration of an interface with the outside;

FIG. 9 shows an example of the configuration of an event message;

FIG. 10 shows another example of XML script;

FIG. 11 shows yet another example of XML script;

FIG. 12 is a block diagram showing a more specific configuration of the database management system 10;

FIG. 13 shows a table relating to operating object names registered in the naming server section 503 shown in FIG. 12;

FIG. 14 is a block diagram showing the configuration of the database operation section 506 shown in FIG. 12; and

FIG. 15 shows the configuration of the root object (RO) map 603 shown in FIG. 14.

### DESCRIPTION OF THE PREFERRED EMBODIMENTS

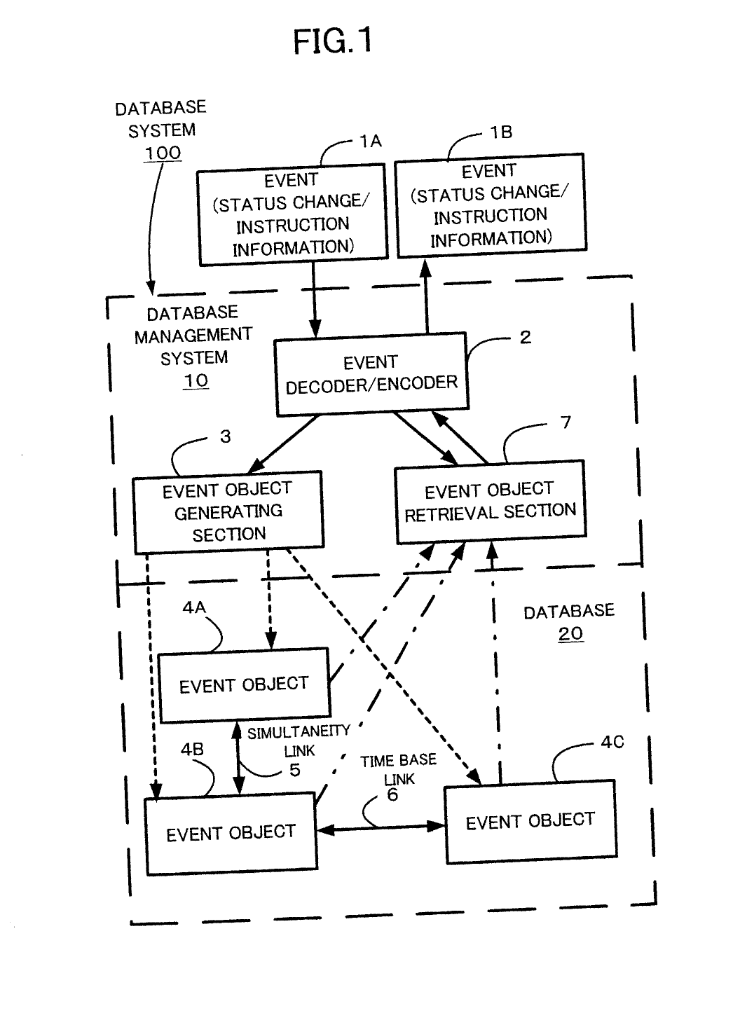

FIG. 1 shows the configuration of the database system according to an embodiment of the present invention.

As shown in FIG. 1, this database system 100 has a database management system 10 and a database 20. The database management system 10 has an event encoder/decoder 2, an event object generating section 3, and an event object retrieval section 7.

In an external system of this database system (not shown), event messages indicating a variety of event contents such as status change information or instruction information, for example, are generated at discrete times, that is, at a variety of times. Further, each event message is sent to this database system 100 from the external system.

In this database system 100, the event encoder/decoder 2 inputs each event message 1A arriving from outside, and generates one or a plurality of different types of touchpoint information (subevent data) by decoding the contents of the event messages 1A. For example, when a status change information event such as “a machine rented to a given customer has failed” arrives, decoding of this event results in the generation of customer touchpoint information with the contents “a rented machine has failed” in relation to “the customer”, machine touchpoint information with the contents “failure” of “the machine”, or other such information.

In accordance with one or a plurality of different types of touchpoint information outputted by the event encoder/decoder 2, the event object generating section 3 newly generates one or a plurality of event objects of different types 4A, 4B, 4C in the database 20, as shown by the dotted line arrows.

Here, an event object signifies one unit of data holding individual touchpoint information. In FIG. 1, three event objects 4A, 4B, 4C are illustrated. Of these event objects, two event objects 4A and 4B are event objects of different types which are generated together from the event message 1A shown in the figure, for example. Further, the other event object 4C is an event object generated from another event message (not shown) which arrives after the illustrated event message 1A, for example. The event object 4C is for example an event object of the same type as the event object 4B (that is, holding the same type of touchpoint information).

Upon generating a new event object as described above, the event object generating section 3 also creates the following relationships (that is, logical links) between this new event object and existing event objects, and when simultaneously generating a plurality of new event objects, between this plurality of new event objects. In other words, as shown in FIG. 1, the event object generating section 3 forms a simultaneity link 5 between the different-type event objects 4A, 4B generated as a result of the same event, and forms a time base link 6 between the event objects 4B, 4C of the same type which are generated at points in time which adjoin one another on the time base.

Here, both the simultaneity link 5 and the time base link 6 are pointers which are appended to a first event object and point to another event object, for example. Also, these links 5, 6 both preferably comprise a pointer from the first event object to the other event object and a pointer from the other event object to the first event object, that is, are bidirectional links.

Based on the result of decoding the contents of an event outputted by the event encoder/decoder 2, the event object retrieval section 7 retrieves desired event objects 4A, 4B, 4C which are mutually related by the above links 5, 6 from the database 8, if required to, as indicated by the alternate long and short dash line arrows. Further, based on the event objects 4A, 4B, 4C retrieved by the event object retrieval section 7, the event encoder/decoder 2 creates a new event message 1B and outputs this new event message 1B to a related external system.

For example, if an instruction information event message such as “retrieve service employee who has performed work for a given customer at a predetermined time” arrives from a given external system, the event encoder/decoder 2 outputs information indicating the customer, the predetermined time, and the like, as a decoding result. Upon receiving such a decoding result, the event object retrieval section 7 locates event objects, which were generated at the predetermined time, from within a chain of customer event objects which are linked by time base links 6, for example, then locates a service employee event object which is directly or indirectly related by a simultaneity link with a located customer event object, and transfers the service employee event object to the event encoder/decoder 2. This being so, based on this service employee event object, the event encoder/decoder 2 generates an event message which indicates the contents of the desired touchpoint information such as “the service employee is ‘so-and-so’”, for example, and outputs this event message to the external system.

Alternatively, by means of the event encoder/decoder 2 and the event object retrieval section 7, it is also possible, in relation to touchpoint information generated by an event message which has arrived, to automatically generate anew event message and output same to the outside. For example, let us assume that a status change information event message such as “a given customer has experienced a machine failure” arrives. At such time, as already described, the event object generating section 3 newly generates an event object such as the touchpoint information for the customer. At the same time, the event object retrieval section 7 retrieves a machine or service employee event object, for example, which is related to this newly generated customer event object, and then, based on the retrieved machine or service employee event object, the event encoder/decoder 2 can newly generate and output an instruction information event such as “a given service employee will go to see the customer and repair the machine” for example.

As described above, according to this database system 100, every time an event is generated, one or more event objects (each) having touchpoint information in accordance with the contents of this event, is (are) automatically produced and stored in the database 20. Further, event objects of different types which relate to the same event are mutually related by simultaneity links 5, and event objects of the same type generated sequentially are related so as to be linked by time base links 6. Furthermore, every time an event is generated, if necessary, event objects relating to the contents of this event are automatically retrieved from the database 20, and new event messages related to the retrieved event objects are automatically generated and outputted.

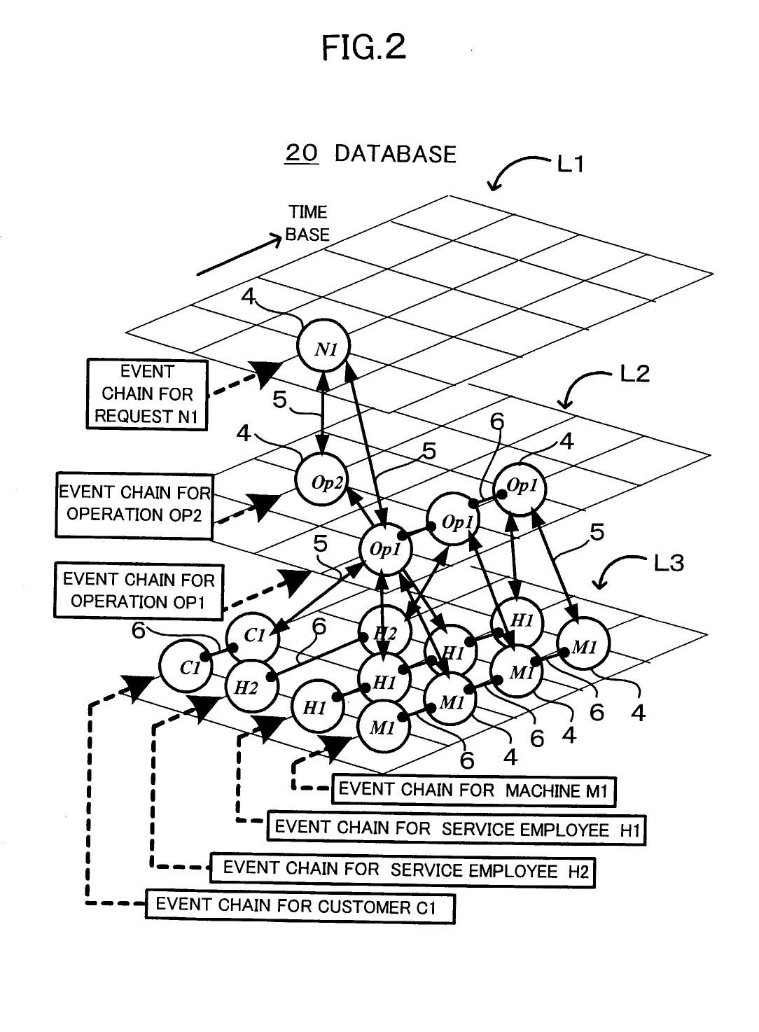

FIG. 2 shows an example of a data structure in the database 20 constructed by the database management system 10 described above. This is an example of a database for an enterprise undertaking machine rentals.

In FIG. 2, each event object 4 is indicated by a circle, the characters in the circle indicating the respective type of event object 4. For example, the characters “N1”, “Op1”, “Op2”, “M1”, “H1”, “H2” and “C1” respectively signify event objects holding touchpoint information with respect to a given specific type of request N1, a given predetermined type of operation Op1, another predetermined type of operation Op2, a given predetermined type of machine M1, a given predetermined service employee H1, another predetermined service employee H2, and a given predetermined customer C1. The seven event object types which are the request N1, operation Op1, operation Op2, machine M1, service employee H1, service employee H2, and customer C1 are expediently classified in FIG. 2 into three layers L1, L2, L3.

In FIG. 2, solid lines forming double-ended arrows which link event objects 4, 4 of different types which belong to different layers are simultaneity links 5. Each of the simultaneity links 5 are shown in FIG. 2 by a single line but are in actuality bidirectional links formed from: an upward facing pointer that points to an event object 4 of an upper layer from an event object 4 of a lower layer, and a downward facing pointer pointing to the event object 4 of the lower layer from the event object 4 of the upper layer. Also in FIG. 2, solid lines with a dot at either end which link event objects 4, 4 adjoining one another along the time base are time base links 6. Each of the time base links 6 are also shown using a single line in FIG. 2, but are actually bidirectional links constituted from a succeeding pointer which points from an earlier event object to a subsequent event object, and a preceding pointer which points from the subsequent event object to the earlier event object.

As shown in FIG. 2, event objects 4, 4 of the same type which adjoin one another in generative sequence are related by time base links 6. As a result, for each type of event object, a chain formed by event objects 4, 4, 4 of this type which are linked serially in generative sequence (called an event chain in the main specification) is formed. For example, a request N1 event chain, an operation Op1 event chain, an operation Op2 event chain, a machine M1 event chain, a service employee H1 event chain, a service employee H2 event chain, and a customer C1 event chain, are formed. Further, although omitted from the figure, the first and last event objects of each event chain are also related by a time base link 6 such that each event chain takes on a ring shape.

Further, as shown in FIG. 2, event objects of different types which are generated in relation with the same event are linked by simultaneity links 5. In the example in FIG. 2, seven event object types are classified into three layers L1, L2, L3. Only different-type event objects belonging to different layers are linked by simultaneity links 5, the simultaneity links 5 not being formed within the same layer. This is one method for preventing an excessive number of simultaneity links 5, but this method need not necessarily be implemented. It is possible to optionally make a decision to extend a simultaneity link 5 between any given object types or to not extend a simultaneity link 5 between any given object types.

As may be seen from FIG. 2, all the event objects 4, 4, . . . in the database 20 may be directly or indirectly related by the simultaneity links 5 and time base links 6. The linked structure between the event objects 4, 4, . . . is a mesh structure. As a result, the retrieval of touchpoint information of different types generated simultaneously, or the retrieval of multifaceted information such as a history of the same type of touchpoint information such as the chronological history of a given machine, for example, can be performed at high speed. Moreover, the storage capacity required for the database is then also small.

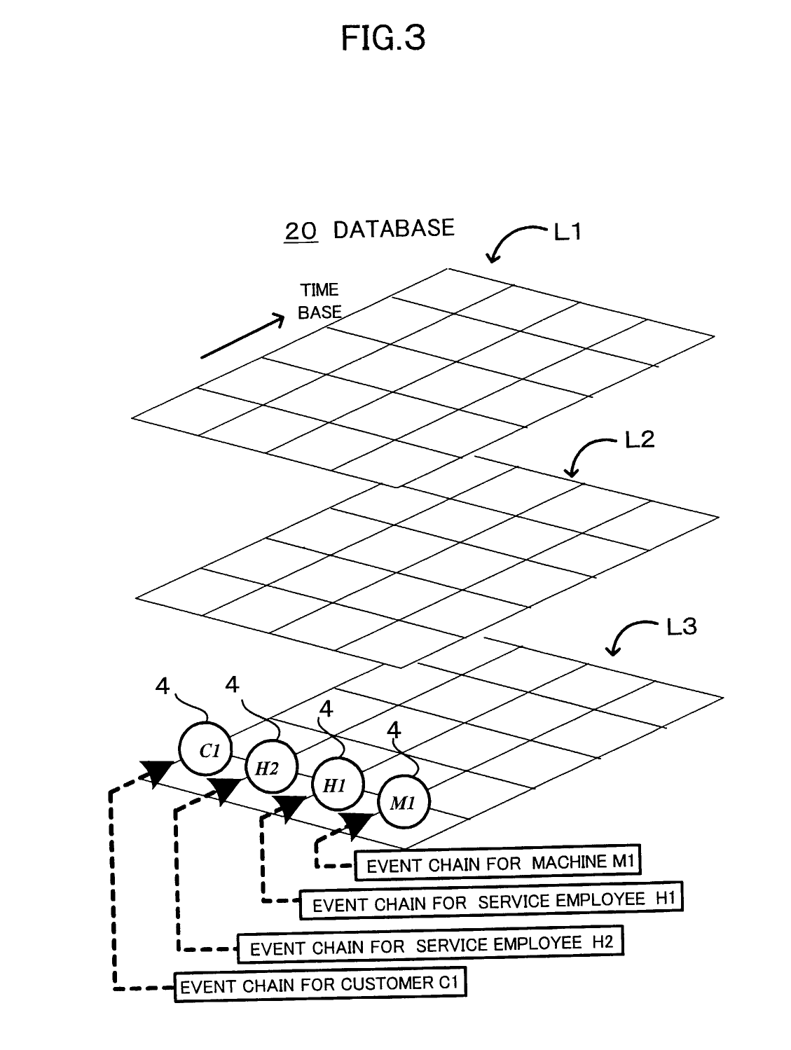

FIGS. 3 through 6 show examples of stages at a midway point toward the construction of a data structure of the kind shown in FIG. 2. Also, event objects and links to which reference numerals have been appended in each of the FIGS. 3 through 6 indicate event objects and links which are newly generated in the stages of these figures.

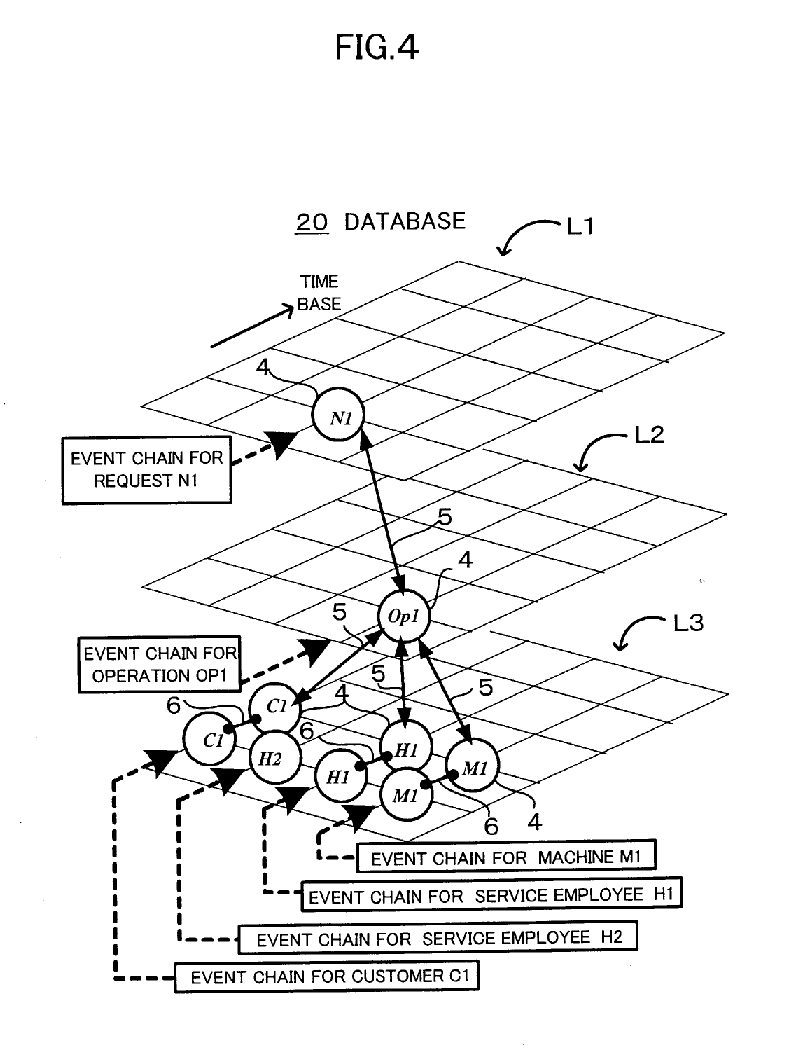

For example, let us assume that, in a given stage, the event objects 4, 4, . . . , which are for machine M1, service employee H1, service employee H2, and customer C1 respectively, as shown in FIG. 3, are newly generated. Suppose that, in the next stage, for example, an event message (instruction information), which has as contents an operation request such as “service employee H1 is to perform a repair operation Op1 on machine M1 of customer C1”, arrives. This being so, as shown in FIG. 4, for example, based on this event message which has arrived, the event objects 4, 4, . . . , which are for the operation request N1, the repair operation Op1, the machine M1, the service employee H1, and the customer C1 respectively, are newly generated and, of these event objects, event objects belonging to different layers are each related by simultaneity links 5, 5. Further, the newly generated event objects 4, 4, 4 for the machine M1, service employee H1 and the customer C1 respectively are each related with a respective previous event object of the same type by time base links 6, 6, 6.

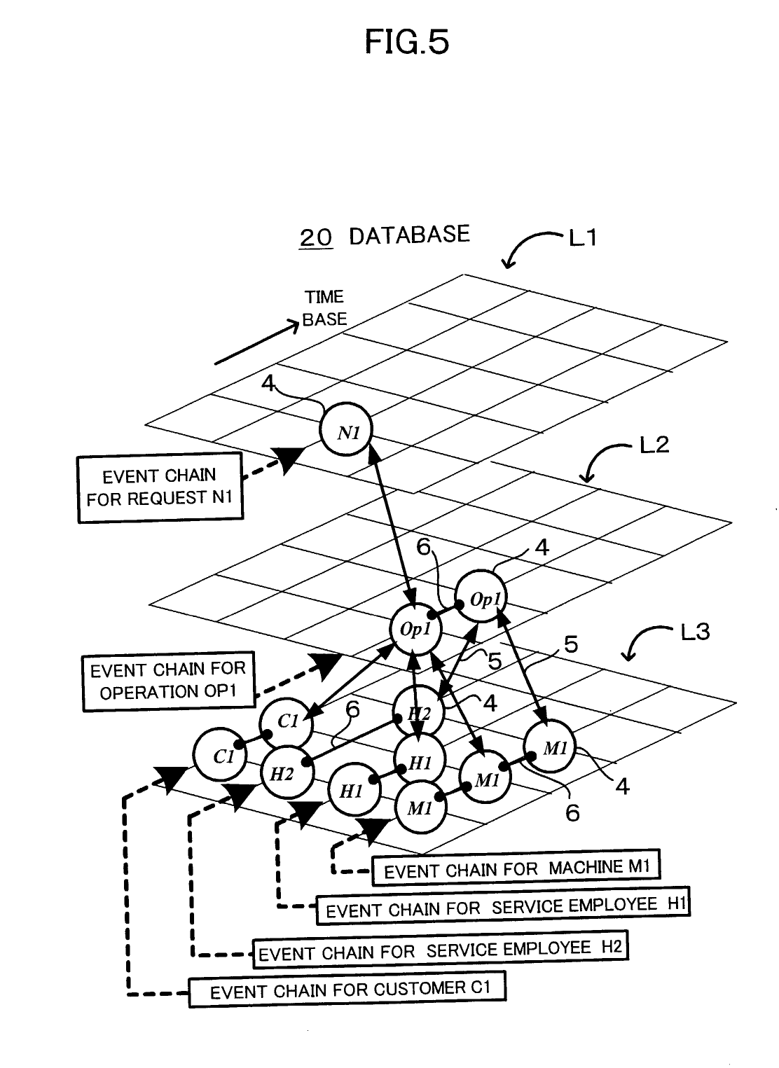

In the next stage, suppose that an event message (status change information), which has as contents an operation report, namely “the service employee H2 has performed the repair operation Op1 on the machine M1” arrives, for example. Accordingly, as shown in FIG. 5 for example, based on this event message, the event objects 4, 4, 4 which are for the repair operation Op1, the machine M1, and the service employee H2 respectively, are newly generated, and, of these event objects, event objects belonging to different layers are each related by simultaneity links 5, 5. Further, these event objects are each related with previous event objects of the same type by time base links 6, 6, 6.

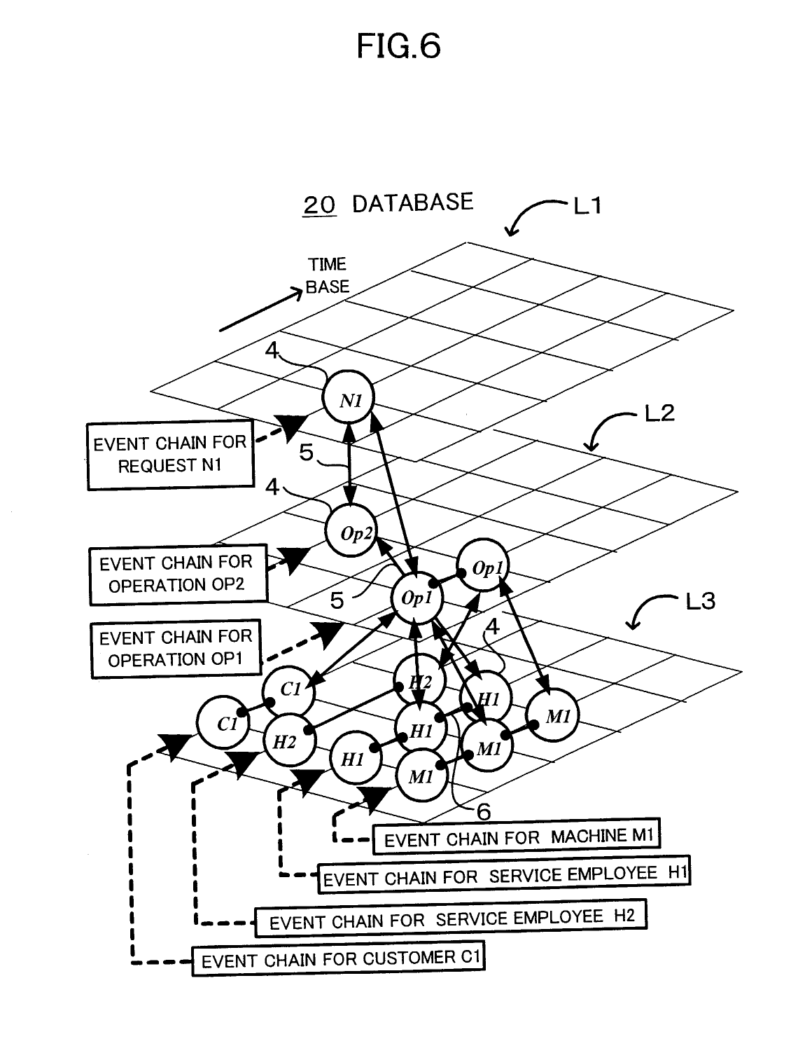

In the next stage, suppose that an event message (status change information) arrives having as contents an operation report which is associated with the operation request N1 of the stage in FIG. 4, namely “the service employee H1 has performed a parts purchase operation Op2 in connection with the previous operation request N1” for example. Accordingly, as shown in FIG. 6 for example, based on this event message, the event objects 4, 4, which are for the parts purchase operation Op2 and the service employee H1 respectively, are newly generated. Further, here, not only are the event objects 4, 4 for the parts purchase operation Op2 and the service employee H1, which are generated together, related by a simultaneity link 5, but also the event object 4 for the parts purchase operation Op2 and the existing event object 4 for the operation request N1, from which the generation of the parts purchase operation Op2 event object 4 originated, are also related by a simultaneity link 5. In addition, the event object 4 for the service employee H1 is related with the previous event object of the same type by a time base link 6.

In the next stage, when an event message having an operation report, namely “the service employee H1 has performed a repair operation Op1 on the machine M1”, for example, arrives, based on this event message, event objects for the service employee H1, the machine M1, and the repair operation Op1 are newly generated, and, as a result, a data structure of the kind shown in FIG. 2 can be achieved.

Also subsequently, every time anew event message arrives, new event objects are generated, whereby the event chains grow and a mesh-shaped linked structure develops.

Let us assume that, in a given stage, a need arises to add a new type of touchpoint information which has hitherto been absent. At such time, the design of the database management system 10 may also be modified so as to generate an addition of an event object for this new type of touchpoint information from this stage, there being no requirement to apply any changes whatever to the data structure already constructed. This new type of event object is connected by means of a simultaneity link 5 with another existing type of event object, and is therefore naturally built into the existing data structure.

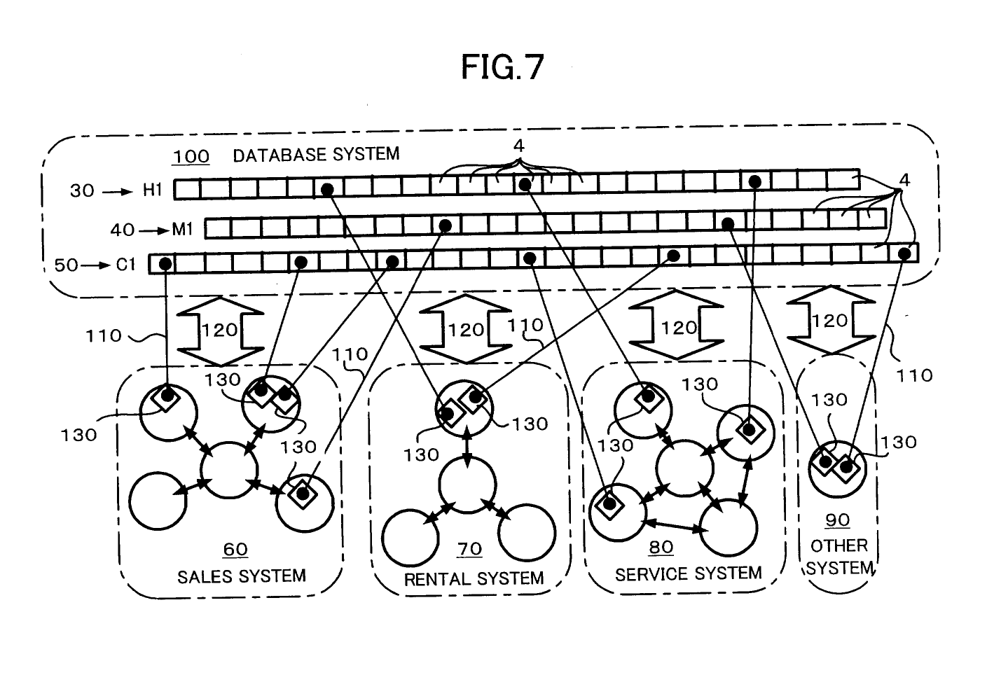

FIG. 7 shows the configuration of an embodiment that implements information sharing between departments in an enterprise by using the database system of the present invention.

In FIG. 7, the database system 100 is the one already described using FIGS. 1 to 6 and has event chains 30, 40, 50 of the kind already described. In the example in FIG. 7, the event chains 30, 40, 50 relate to a predetermined service employee H1, a predetermined machine M1, and a predetermined customer C1 respectively. The individual rectangles 4 in the event chains 30, 40, 50 indicate individual event objects. Simultaneity links and time base links linking the event objects 4, 4, . . . have been omitted from the illustration of FIG. 7.

This enterprise undertakes machine rentals, for example, and has a variety of business task systems distinguished by the department or type of business task such as a sales system 60, rental system 70, a service system 80, and another system 90, or the like. Circles drawn within the limits of each of the business task systems 60, 70, 80, 90 in FIG. 7 indicate individual databases or individual applications contained within the business task systems. These business task systems 60, 70, 80, 90 and the database system 100 according to the present invention are each connected via an intranet or the Internet, for example, or via another suitable communication network, and are capable of mutual communication via a given standard interface 120.

The event objects 4, 4, . . . in the database system 100 can also be formed such that all the data of the respective touchpoint information are held in the event objects themselves. However, in this embodiment, the event objects are not formed in this manner. In other words, in this embodiment, data forming each of the touchpoint information entities (entity data) are not contained in the event objects 4, 4, . . . themselves in the database system 100. These touchpoint information entity data are a variety of data 130, 130, . . . which are stored in the business task systems 60, 70, 80, 90 outside the database system 100. Further, these entity data 130, 130, . . . , and corresponding event objects 4, 4, . . . , are each linked by logical links 110. Accordingly, only data for identification or indexing, or pointer data, which serve to specify or indicate respective touchpoint information are contained in the event objects 4, 4, . . . , themselves.

A variety of types of touchpoint information 130, 130, . . . , stored in the business task systems 60, 70, 80, 90 of types distinguished by department or by type of business task are mutually related via the so constituted database system 100. Further, because all of the business task systems 60, 70, 80, 90 also communicate with the database system 100 through the standard interfaces 120, a variety of touchpoint information possessed by other business task systems can be retrieved or referenced, such that information sharing between departments is implemented. Each time an event such as a status change is generated in the respective business task systems 60, 70, 80, 90, new event objects are automatically added to the database system 100, and these event objects and corresponding touchpoint information 130 in the business task system 60, 70, 80, or 90 are linked, meaning that database integration between departments progresses gradually. Further, when a given event (for example, a status change such as a machine failure) is produced in a given business task system, a new event message (for example, instruction information to repair the machine) which is related with this event is automatically generated by the database system 100 and can also be sent, for example, to a related business task system. Moreover, the storage capacity of the database system 100 itself is then small.

The configuration shown in FIG. 7 can be applied similarly, not only to a case of implementing information sharing between a plurality of departments in an enterprise, but also to a case of implementing information sharing between enterprises by integrating different enterprise systems.

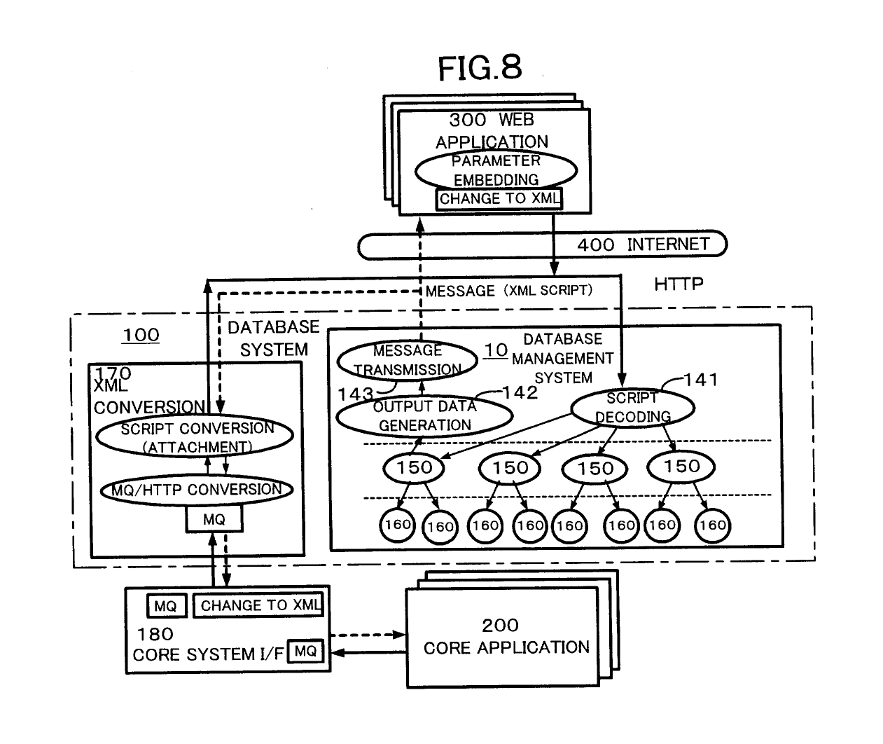

FIG. 8 more specifically shows a software configuration inside the database system of the embodiment in FIG. 7 and the configuration of an interface with an external system.

The database system 100 is capable of communicating, via a core system interface 180, with core applications 200 of a type possessed by a few core business task systems within or outside an enterprise. The database system 100 is also capable of communicating, via the Internet 400, for example, with web applications 300 of a type possessed by a personal computer, mobile telephone device, or the like, within or outside an enterprise. The database management system 10 in the database system 100 performs communications using the HTTP protocol, for example, and messages sent and received are, for example, in the form of an XML (Extensible Markup Language) script described using XML.

In addition to the database management system 10 which constitutes the core of the database system 100, the database system 100 has an XML conversion section 170 (this system 100 naturally also has the database 20 shown in FIGS. 1 to 6, same being omitted in FIG. 7). The XML conversion section 170 receives messages from the core applications 200 in a message queue MQ via the core system interface 180, creates one or more XML scripts from these messages, and, if necessary, adds a special XML script for the database management system 10 to the XML script(s) to thereby create event messages containing this XML script. Further, the XML conversion section 170 sends these event messages to the database management system 10 using the HTTP. The XML conversion section 170 receives an event message containing one or more XML scripts from the database management system 10, converts this event message by means of a procedure that is the reverse of that described above into a message created for the core application 200, and sends this message to the core system interface 180.

The database management system 10 in the database system 100 has, in a computer program thereof, a script decoding method 141, an output data generating method 142, and a message sending method 143. These methods combined as a whole are equivalent to the event decoder/encoder 2 shown in FIG. 1. In other words, the script decoding method 141 reads received messages and decodes the event contents described therein. Further, based on event objects which are retrieved, the output data generating method 142 creates an event message describing the new event contents. The message sending method 143 sends the event message thus created to a related external application.

A few blocks in the database system 10 which are indicated using the reference number 150 are medium granularity methods, which medium granularity methods 150, 150, . . . , each carry out functions such as the creation, linking, retrieval, referencing, or the like, of event objects and are provided in the event object generating section 3 and the event object retrieval section 7 which are shown in FIG. 1. A few small granularity methods 160, 160 are subordinate to each medium granularity method 150. These small granularity methods 160, 160 perform the creation, linking, retrieval and referencing object operations which are to be carried out by medium granularity methods 150, following allocation through distinction of event object types, namely machine, customer, service employee, or the like.

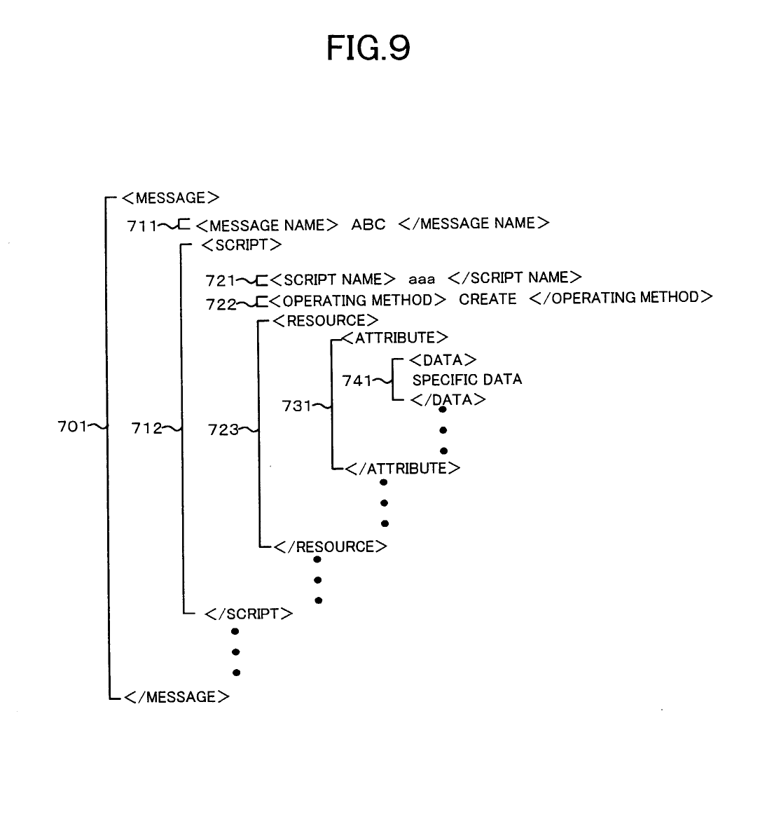

FIG. 9 shows an example of the configuration of the event message described above.

In the example shown in FIG. 9, one event message 701 begins with the tag <message> and ends with the tag </message>. The message name 711 is contained in the event message 701 and is inserted between the tag <message> and the tag </message>. The message name 711 indicates the type of this event message (such as, for example, the type of event such as an instruction information event or status change information event, and which of the core applications generated this event message). Further, one or more XML scripts 712 is (are) contained in the event message 701, each of the XML scripts 712 being inserted between the tag <script> and the tag </script>.

Each script 712 contains a script name 721 which is inserted between the tag <script name> and the tag </script name>. An operating method 722 is contained in each script 712 and is inserted between the tag <operating method> and the tag </operating method>. The operating method 722 indicates a method of operation with respect to the event objects which is to be performed on the basis of this script. For example, operating methods 722 include “CREATE”, “SEND”, and “SELECT”.

The operating method “CREATE” is an operating method which requests that one or more new event objects be generated and stored in the database 20 (refer to FIG. 1) by using data contained in the script. The operating method “SEND” is an operating method which requests that a new event message be generated and sent to an external system by using data contained in the script. In addition, the operating method “SELECT” is an operating method which requests that one or more event objects be retrieved from within the database 20 by using data contained in the script.

The operating method “CREATE” is described in the script 712 shown in FIG. 9. Thus, this script 712 requests that one or more new event objects be generated. Data indicating the contents of one or more new event objects which are newly generated are contained in the script 712. These data are divided by means of the tags <resource> and </resource> for every event object which is newly generated (for example, an event object for the machine M1, an event object for the operation Op1, and the like). Furthermore, the data of every event object are divided by means of the tags <attribute> and </attribute> for each attribute which the event object possesses (for example, name, identification code, value, status, and the like).

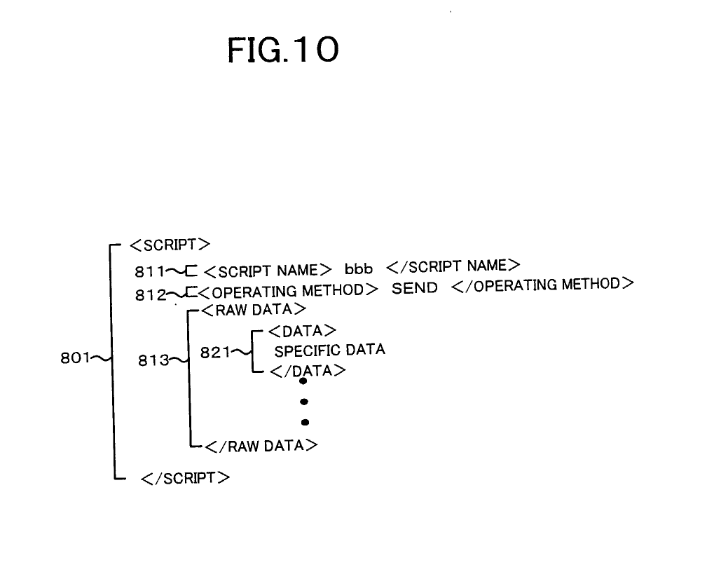

FIG. 10 shows an example of another script 801.

Because the operating method “SEND” is described in the script 801, a request is made that a new event message be generated and sent to an external system. In this script 801, data 813 which are to be inputted to an event message which is newly generated are described in an area inserted between the tags <raw data> and </raw data>.

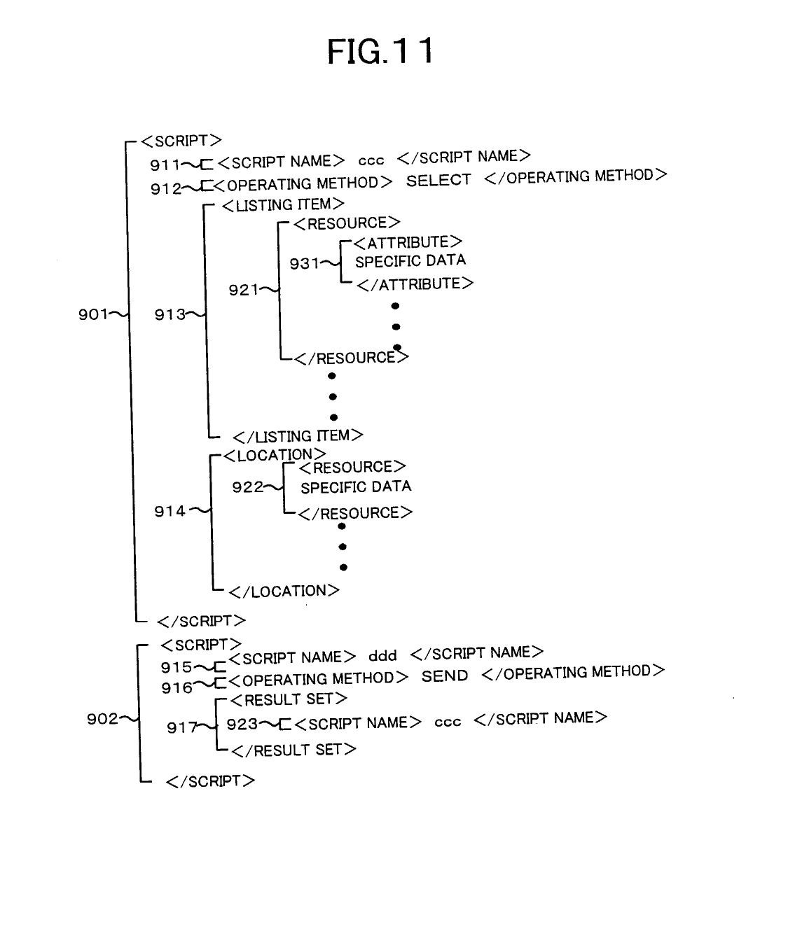

FIG. 11 shows examples of still further scripts 901, 902.

The two scripts 901, 902 shown in FIG. 11 are scripts that request that event object retrieval be performed and that a new event message into which the retrieval result is introduced be created and sent to an external system.

In other words, because the operating method “SELECT” is described in the first script 901, retrieval of one or more event objects from the database is requested. In this script 901, data 913, which indicates the attributes of the event object(s) which is (are) the subject(s) of retrieval, is described in an area inserted between the tags <listing item> and </listing item>. Furthermore, data 914, which indicates the retrieval location in the database (for example, the type of event object), is described in an area which is inserted between the tags <location> and </location>.

Further, with respect to the second script 902, as a result of the operating method “SEND”, a request is made that a new event message be created and outputted to the outside. In this script 902, the script name “ccc” 923 is described in an area 917 inserted between the tags <result set> and </result set>. This means that a retrieval result is set as a new event message by script having the name “ccc”, namely the above-described script 901.

The above-described configurations for an event message and for script contained therein are only a few illustrations, it being possible to adopt event messages and script having a variety of other configurations.

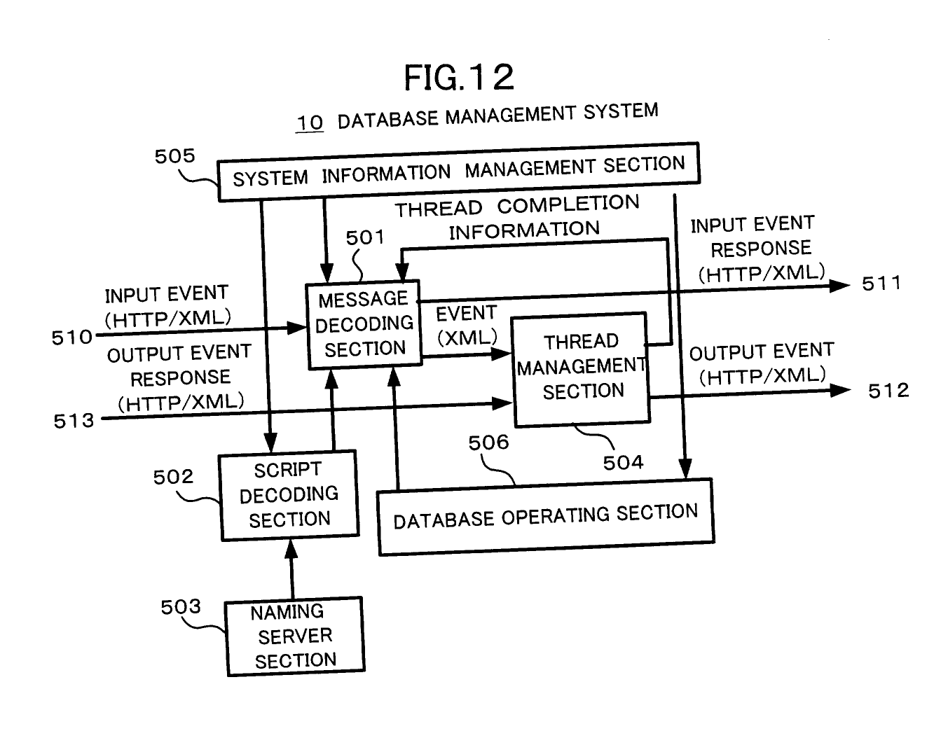

FIG. 12 shows a more specific configuration of the database management system 10.

As shown in FIG. 12, the message decoding section 501 inputs an event message 510 written in XML, stores the inputted event message 510 to memory, and serially decodes one or more scripts contained in the event messages 510 using a script decoding section 502. The message decoding section 501 also addresses and sends back an input event response message 511, which indicates that an event message has been inputted, to an external system constituting the origin of this event message transmission.

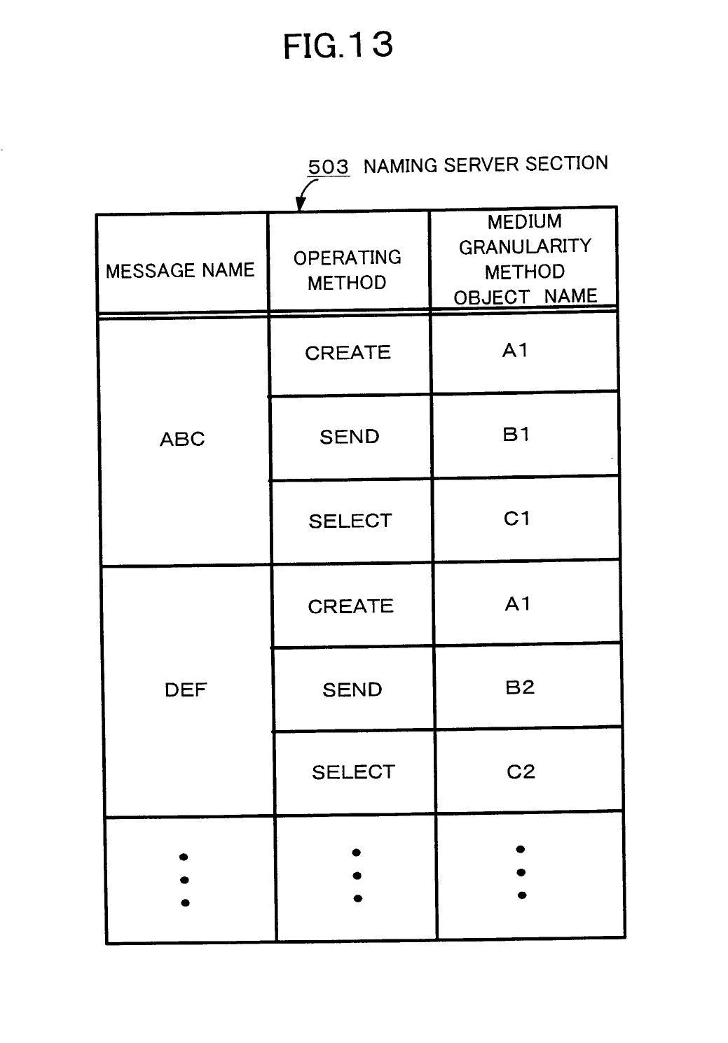

The script decoding section 502 decodes individual scripts and rewrites these scripts with reference information referring to an operating object which executes medium granularity methods 150 (refer to FIG. 8) corresponding with the script. At such time, the script decoding section 502 uses a naming server section 503 to determine operating objects which correspond with the scripts. As illustrated in FIG. 13, combinations of all of the message names which can be attached to an event message and of all of the operating methods which can be described in the scripts, as well as names or identifiers of objects which perform the medium granularity methods corresponding with each of these combinations, are, for example, registered beforehand in the naming server section 503 in the form of a lookup table or the like. According to FIG. 13, for example, the operating object “A1” corresponds with script which has the operating method “CREATE” contained in an event message having the message name “ABC”. Naturally, this object “A1” is an object having a function to execute the operating method “CREATE”, that is, has a medium granularity method that generates a new event object and registers same in the database. The correspondence relationships between the combinations of message names and operating methods, and operating objects, of the kind shown in FIG. 13, can be registered by system administrators and can also be rewritten at any time according to requirements.

Referring once again to FIG. 12, the database operating section 506 has all the operating objects of which the names have been registered in the naming server section 503. The message decoding section 501 uses reference information for operating objects corresponding with each script converted by the script decoding section 502 to thereby call corresponding operating objects in the database operating section 506. This reference information contains parameters which reflect the names of these operating objects and data within the scripts, and the like (for example, the reference numerals 721 to 723 in FIG. 9, 811 to 813 in FIG. 10, 911 to 914 or 915 to 917 in FIG. 11). The called operating objects use parameters contained in this reference information to execute data processing requested by the scripts. This data processing involves for example, when the script operating method is “CREATE”, generating new event objects on the basis of the data of the script and registering such event objects in the database 20 (refer to FIG. 1), or when the script operating method is “SEND”, involves generating a new event message on the basis of the data of the script, or when the script operating method is “SELECT”, involves retrieving event objects from the database 20 on the basis of the data of the script. When a given operating object generates new event objects, the operating object also generates at the same time simultaneity links and time base links between the new event objects and other event objects.

When an operating object of the database operating section 506 generates a new event message, the message decoding section 501 transfers the generated event message to a thread management section 504. The transmission thread for transmitting the received event message to an address external system is established in the thread management section 504. The transmission thread addresses and outputs this event message to the external system which is to receive the event message. The event message 512 outputted by the transmission thread passes through the XML conversion section 170 (see FIG. 8) and is transmitted to the address external system. When an output event response message 513, which indicates that this event message has been received, is received by the thread management section 504 from the external system, the thread management section 504 judges that the output of the event message 512 of this transmission thread is complete and returns thread completion information to the message decoding section 501 to end processing.

When a plurality of event messages for transmission are generated, if these event messages must be transmitted in order in accordance with a predetermined sequence, the message decoding section 501 controls the event message transmission period by transferring a preceding event message to the thread management section 504 and, thereafter, after receiving thread completion information for the preceding event message, transferring the next event message to the thread management section 504. On the other hand, if this plurality of event messages can also be transmitted using any sequence, the message decoding section 501 transfers these event messages to the thread management section 504 simultaneously or in irregular order. Upon receiving a plurality of event messages simultaneously, the thread management section 504 simultaneously executes a plurality of transmission threads, which handle these event messages, in parallel.

When executing respective processing, the above-described message decoding section 501, script decoding section 502 and database operating section 506 reference system information managed in a system management section 505. This system information includes definition information, constraint information, and the like, relating to event message and event object structures (for example, decodable script, types of event object which can be generated, types of event chain, and links to higher and lower layers which each type of event object should possess). By referencing such system information, processing performed by the message decoding section 501, script decoding section 502 and database operating section 506 can be controlled correctly. System administrators are able to register optional definition information, constraint information, and the like in the system management section 505, and can also change this system information at any time according to requirements. For example, when a need arises to add, to the database, event objects for a new type of touchpoint information which has hitherto been absent, definition information, constraint information, and the like relating to this new type of event object can be added to and registered in the system management section 505.

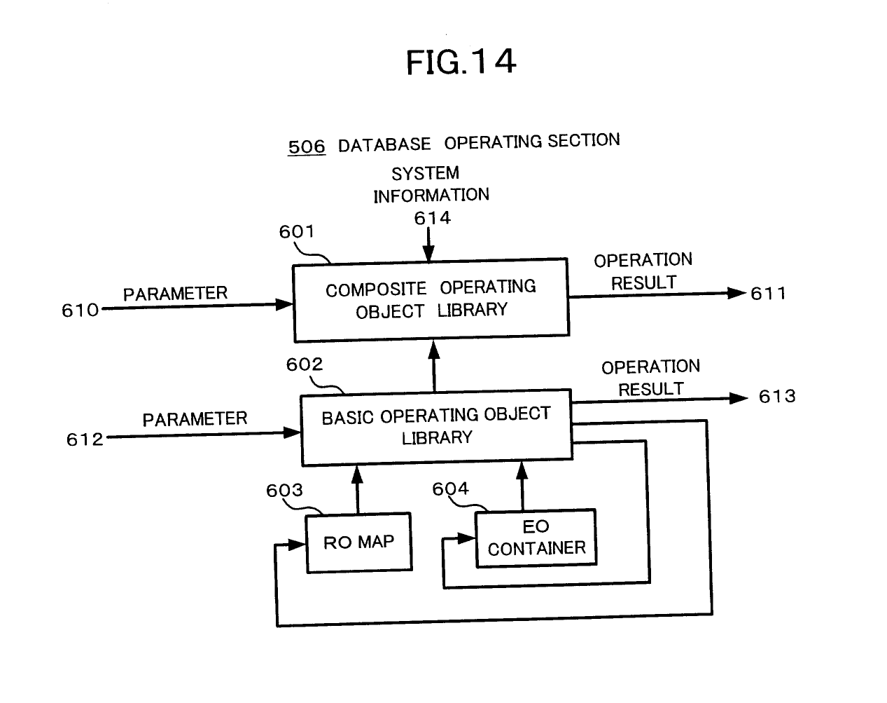

FIG. 14 shows the configuration of the database operation section 506 shown in FIG. 12.

In FIG. 14, the composite operating object library 601 is a library for collecting operating objects which perform the above-described variety of medium granularity methods. As described hereinabove, such operating objects include: an operating object for generating new event objects and registering same in the database, an operating object for creating a new event message for an external system, an operating object for retrieving event objects from the database, and the like. As described hereinabove, each of the operating objects uses a parameter 610 which is transferred from the message decoding section 501 shown in FIG. 12, references system information 614 registered in the system information management section 505 shown in FIG. 12, performs an operation such as the generation or retrieval of event objects of the kind described above or the generation of an event message, and then outputs an operation result 611.

An operating object which is going to generate a new event object with respect to given touchpoint information and register this new event object in the database, registers, when not one event object of the touchpoint information is yet present in the database, a generated event object in the database by determining a root object for the event chain of the touchpoint information. Here, a root object is an event object that constitutes the starting point for retrieval of an event object in this event chain. Generally, the event object in the event chain which is temporally the first to be registered is selected as the root object. However, there are also cases where, when performing retrieval, it is more favorable to make a recent event object the root object rather than an event object that is already excessively old. Consequently, where required, a given operating object may also be rendered capable of automatically changing a root object.

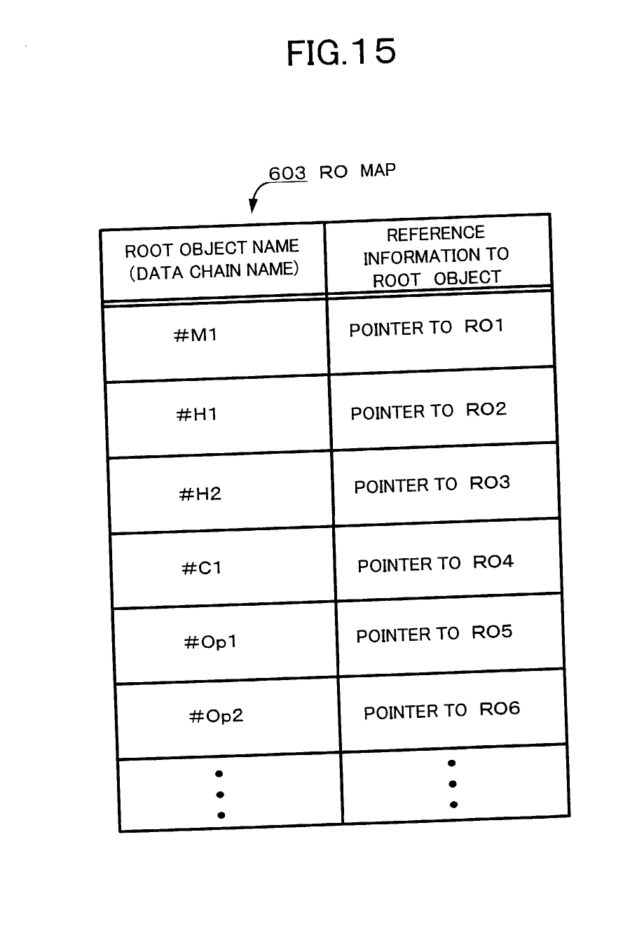

The event object (EO) container 604 in FIG. 14 is a region for storing event objects which are in the database. Further, as illustrated in FIG. 15, a root object (RO) map 603 is for registering reference information referring to the root object of each event chain (for example, pointers to addresses in the EO container 604 for each root object, and the like). In the example in FIG. 15, pointers to the root objects RO1, RO2, . . . for these event chains are related with the event chain names #M1, #H1, . . . for a variety of touchpoint information types, namely machine M1, service employee H1, etc. By referencing such an RO map 603, the root objects of a variety of event chains are found directly, meaning that high speed event object retrieval starting from a root object is feasible.

Each of the operating objects in the composite operating object library 601 described above use a basic operating object in a basic operating object library 602 in order to operate respective medium granularity methods. The basic operating object library 602 collects a plurality of basic operating objects for performing a variety of basic operations with respect to event objects in the RO map 603 and EO container 604. Such basic operations include, for example, writing a new event object to the EO container 604, retrieving, reading and erasing an event object in the EO container 604, adding new root object reference information to the RO map 603, and reading, rewriting and erasing root object reference information in the RO map 603. The basic operating objects are each called by a medium granularity method operating object in the composite operating object library 601, use a parameter 612 transferred from this medium granularity method operating object to perform each of these basic operations, and return an operation result 613 to the medium granularity method operating object.

An embodiment of the present invention was described hereinabove, which embodiment is an illustration serving to describe the present invention and is not intended to limit the scope of the present invention to this embodiment alone. Consequently, the present invention can also be implemented according to a variety of other aspects without departing from the spirit of the present invention.

What is claimed is:

1. A database management system, comprising:
event message decoding means for inputting and decoding an event message indicating an event;
event object generating means for generating in a database, in response to a decoding result for each event message, one or more types of event object each having one or more types of touchpoint information in accordance with said decoding result;
means for forming a simultaneity link between event objects of different types which are generated from a same event; and
means for forming a time base link between event objects of a same type that adjoin one another on a time base.

2. The database management system according to claim 1, further comprising:
event object retrieving means for retrieving from said database, in response to a decoding result for each event message, one or more desired event objects which are directly or indirectly related by said simultaneity link or said time base link with respect to one or more types of touchpoint information in accordance with said decoding result.

3. The database management system according to either one of claims 1 and 2, further comprising:
event message creating means for creating, based on an event message inputted from outside or a retrieved event object, a new event message which is outputted to outside.

4. The database management system according to either one of claims 1 and 2, further comprising:
message converting means for inputting an external message relating to an event outputted from an external system and for converting said inputted external message into said event message and outputting same to said event message decoding means.

5. The database management system according to claim 3, wherein said message converting means further inputs an event message outputted from said event message creating means, converts said inputted event message into an external message for said external system and outputs this converted external message to said external system.

6. The database management system according to claim 3, wherein at least one operating method selected from among a plurality of types of operating method, and data related to said event, are described in an event message inputted to said event message decoding means; said event message decoding means selects, in accordance with the operating method described in a decoded event message, said event object generating means, said event object retrieving means or said event message creating means; and said selected event object generating means, said event object retrieving means or said event message creating means performs respective processing using data described in said decoded event message.

7. The database management system according to claim 6, comprising:
a plurality of operating objects constituting said event object generating means, said event object retrieving means and said event message creating means and
operating object information for defining operating objects corresponding with a variety of event message types which can be inputted from outside and with a variety of operating methods which can be described in each event message,
wherein said event message decoding means selects, based on said operating object information, one or more operating objects corresponding with said decoded event message type and with an operating method described in said event message; the selected operating object(s) perform(s) respective processing using data described in said decoded event message; and said operating object information is rewritable.

8. The database management system according to claim 1, further comprising:
system information management means for storing system information comprising definition information and constraint information relating to the structure of event messages and event objects,
wherein said event message decoding means, event object generating means, said simultaneity link forming means, and said time base link forming means use system information in said system information management means to correctly control respective processing.

9. A database construction method, comprising the steps of:
inputting and decoding an event message indicating an event;
generating in a database, in response to a decoding result for each event message, one or more types of event object each having one or more types of touchpoint information in accordance with said decoding result;
forming a simultaneity link between event objects of different types which are generated from a same event; and
forming a time base link between event objects of a same type that adjoin one another on a time base.

10. A computer program for causing a computer to execute a database construction method, comprising the steps of:
inputting and decoding an event message indicating a generated event;
generating in a database, in response to a decoding result for each event message, one or more types of event object each having one or more types of touchpoint information in accordance with said decoding result;
forming a simultaneity link between event objects of different types which are generated from a same event; and
forming a time base link between event objects of a same type that adjoin one another on a time base.

11. An event management database, comprising:
event objects of a plurality of types, each having touchpoint information in accordance with the contents of a generated event,
wherein event objects of different types which are based on a same event are interrelated by a simultaneity link, and event objects of a same type which adjoin one another on a time base are interrelated by a time base link to form event chains of each event object type.

12. The database according to claim 11, wherein touchpoint information entity data possessed by event objects in said event chains are not present in said event objects themselves but rather are present in one or more external systems outside said database, and wherein said event objects are related with touchpoint information entity data in said external systems by means of a logical link.

13. An integrated system, comprising:
an event management database system; and
one or more external systems capable of communicating with said database system,
wherein said database system comprises event objects of a plurality of types, each having touchpoint information in accordance with the contents of an event generated in said external systems; event objects of different types which are based on a same event are interrelated by a simultaneity link, and event objects of a same type which adjoin one another on a time base are interrelated by a time base link to form event chains of each event object type; and each of said external systems is capable of accessing touchpoint information relating to an event generated in another external system by communicating with said database system.

14. The integrated system according to claim 13, wherein said external systems have touchpoint information entity data possessed by event objects in said event chains, and each of said entity data are related with corresponding event objects in said event chains by means of a logical link.
